(19) United States
(12) Patent Application Publication
(10) Pub. No.: US 2010/0309096 A1
(43) Pub. Date: Dec. 9, 2010

(54) DISPLAY DEVICE AND ITS DISPLAY METHOD

(76) Inventor: Ippei Inoh, Osaka (JP)

Correspondence Address: BIRCH STEWART KOLASCH & BIRCH, PO BOX 747, FALLS CHURCH, VA, 22040-0747, US

(21) Appl. No.: 12/745,200

(22) PCT Filed: Aug. 5, 2008
(86) PCT No.: PCT/JP2008/002113

§ 371 Date: May 27, 2010

(30) Foreign Application Priority Data
Dec. 11, 2007 (JP) 2007-319194

(51) Int. Cl. G09G 5/00

(52) U.S. Cl. 345/5

(57) ABSTRACT

When a main display element is in an active mode, all of a plurality of unit display regions of a sub display element are switched to a transmitting portion for displaying display information of the main display element. When the main display element is in a sleep mode in which the main display element provides black or dark display, the plurality of unit display regions of the sub display element are switched to the transmitting portion for displaying the black or dark display information of the main display element, and a reflecting portion for displaying white or bright display information by blocking light from the main display element and reflecting light from a viewer side.

### TECHNICAL FIELD

The present invention relates to display devices and display methods thereof.

### BACKGROUND ART

In recent years, techniques relating to sleep mode functions have been studied and developed in order to reduce power consumption required to display information on display screens of mobile phones, personal digital assistants (PDAs), copiers, notebook computers, and the like. One known example of the sleep mode functions is a function to display at least a minimum amount of information on a sub screen even when a main screen is off and is not displaying any information, thereby reducing power consumption.

As an example of such a technique, Patent Document 1 discloses a technique for implementing the above function by providing a display device with a configuration for selecting a main display element or a sub display element according to the brightness around the display device, so that the display on a main screen remains on memory cholesteric liquid crystal like a snapshot when the main screen of the display device is turned off.

Patent Document 2 discloses a technique for performing display control of Patent Document 1. In the technique of Patent Document 2, however, a pattern for a sub screen is displayed in advance on a main screen while rewriting the sub screen, since the memory sub screen is rewritten at a low speed.

### CITATION LIST

### Patent Document

PATENT DOCUMENT 1: Japanese Published Patent Application No. 2006-133346

PATENT DOCUMENT 1: Japanese Published Patent Application No. 2006-243329

### SUMMARY OF THE INVENTION

### Technical Problem

However, in the configuration for selecting the main display element or the sub display element according to the brightness around the display device as described in Patent Document 1, the display screen is automatically switched to the main display in a dark environment such as in a pocket, in a bag, in a movie theater, and in an unlighted (dark) office. Thus, not only power consumption of the display device cannot be reduced, but also the main display is turned on when not desired.

In the technique described in Patent Document 2, the main screen of the display device is turned on every time the sub screen is rewritten in a sleep mode, which is not desirable for reducing power consumption. Moreover, in the case where the sub screen of the display device is formed by passive driving cholesteric liquid crystal, it takes long to draw an image on the sub screen at low temperatures, whereby the main screen is in an on state for an extended period of time. This is also not desirable for reducing power consumption.

### Solution to the Problem

The present invention was developed in view of the above problems, and it is an object of the present invention to provide a display device that satisfactorily controls switching of display between a main screen and a sub screen at desired timings, and is capable of reducing power consumption, and a display method thereof.

A display method of a display device according to the present invention is a display method of a display device having a main display element, and a sub display element provided on a viewer side of the main display element, the sub display element having a plurality of unit display regions that are switched to a reflecting portion and a transmitting portion by rewriting display information, the method including: when the main display element is in an active mode, switching all of the plurality of unit display regions to the transmitting portion for displaying display information of the main display element; and when the main display element is in a sleep mode in which the main display element provides black or dark display, switching the plurality of unit display regions to the transmitting portion for displaying the black or dark display information of the main display element, and a reflecting portion for displaying white or bright display information by blocking light from a main display element side and reflecting light from a viewer side.

A display device according to the present invention, which displays information by the above display method, is a display device including: a main display element; and a sub display element provided on a viewer side of the main display element, wherein the sub display element has a plurality of unit display regions that are switched to a reflecting portion and a transmitting portion by rewriting display information, wherein when the main display element is in an active mode, all of the plurality of unit display regions are switched to the transmitting portion for displaying display information of the main display element; and when the main display element is in a sleep mode in which the main display element provides black or dark display, the plurality of unit display regions are switched to the transmitting portion for displaying the black or dark display information of the main display element, and a reflecting portion for displaying white or bright display information by blocking light from a main display element side and reflecting light from a viewer side.

With this configuration, when the main display element is in the active mode, all of the plurality of unit display regions of the sub display element transmit the information displayed on the main display element without blocking any of the information, whereby the display information is displayed to the viewer. When the main display element is in the sleep mode, the plurality of unit display regions of the sub display element are switched to the transmitting portion for displaying the black or dark information displayed on the main display element, and the reflecting portion for displaying the white or bright display information by blocking light from the main display element and reflecting light from the viewer side, whereby the information is displayed to the user. Thus, the main screen is not automatically turned on in a dark environment and the like, and switching of display between the main screen and the sub screen can be satisfactorily controlled at desired timings. In the case where the display on the main screen is not needed, but simple information such as time is desired to be displayed, the main display element is turned off so that the simple information can be displayed only by the sub display element. This can satisfactorily reduce power consumption of the display device.

According to the display method of the present invention, when the main display element is in the sleep mode, the display on the sub display element may be updated at regular intervals.

With this configuration, the display on the sub display element is updated at regular intervals when the main display element is in the sleep mode. Thus, the simple information can be rapidly and continuously obtained on the sub screen.

According to the display device and the display method of the present invention, the sub display element may be a memory display element.

With this configuration, the sub display element is a memory display element. Thus, even if the main screen and the sub screen are turned off after the display state of the sub display element is switched, the sub display element can maintain that display state. This can more satisfactorily reduce power consumption of the display device.

According to the display device and the display method of the present invention, the memory display element may be a cholesteric liquid crystal display element that reflects visible light.

With this configuration, the memory display element is a cholesteric liquid crystal display element that reflects visible light. Thus, black display on the main display element in the sleep mode can be easily used as black display transmitted by the cholesteric liquid crystal that reflects visible light. This simplifies the configuration of the display device.

According to the display device and the display method of the present invention, a front light may further be provided on a viewer side of the sub display element to display display information.

With this configuration, the front light is further provided on the viewer side of the sub display element to display the display information. This increases the visibility of the display screen of the display device. Moreover, this can satisfactorily reduce alignment disorder of a display medium, which is caused by an external pressure that is applied to the display screen of the display device. Since the front light can be independently turned on/off, the screen of the display device can be easily turned on/off by not turning on the front light in a sufficiently bright environment or when not desired.

According to the display device and the display method of the present invention, the front light may be controlled by an illuminance sensor.

With this configuration, since the front light is controlled by the illuminance sensor, the front light can be arbitrarily and satisfactorily controlled in a dark environment and the like.

### ADVANTAGES OF THE INVENTION

The present invention is capable of providing a display device that satisfactorily controls switching of display between a main screen and a sub screen at desired timings, and is capable of reducing power consumption, and a display method thereof.

### BRIEF DESCRIPTION OF THE DRAWINGS

FIG. 1 is a cross-sectional view of a display device according to a first embodiment.

FIG. 2 is a table showing the relation between each mode of a main display element and the display state of a sub display element.

FIG. 3 shows plan views of the main display element in each mode, and plan views of the sub display element and cross-sectional views of the display device, which correspond to each mode of the main display element.

FIG. 4 is a cross-sectional view of a display device according to a second embodiment.

FIG. 5 is a table showing the relation between each mode of a main display element and the display state of a sub display element.

FIG. 6 is a cross-sectional view of a display device according to a third embodiment.

FIG. 7 is a table showing the relation between each mode of a main display element and the display state of a sub display element.

FIG. 8 is a flowchart of a display system of the display device.

FIG. 9 is a schematic view of a display device according to a fourth embodiment.

FIG. 10 is a table showing the relation between each mode of a main display element and the display state of a sub display element.

FIG. 11 is a flowchart of a display system of a display device.

FIG. 12 is a flowchart of display on a screen of a mobile phone.

FIG. 13 is a flowchart of display on a screen of a copier.

### DESCRIPTION OF REFERENCE CHARACTERS

10, 20, 30, 40 Display Device
11, 21, 31, 41 LCD Element
12, 22, 32, 42 Backlight
13, 23, 33, 43 Main Display Element
14, 24, 34, 44 Sub Display Element
35, 45 Front Light
46 Front Light Switch
48 Illuminance Sensor

### DESCRIPTION OF EMBODIMENTS

Display devices and display methods thereof according to embodiments of the present invention will be described in detail below with reference to the accompanying drawings. Note that the present invention is not limited to the following embodiments.

### First Embodiment

(Configuration of Display Device 10)

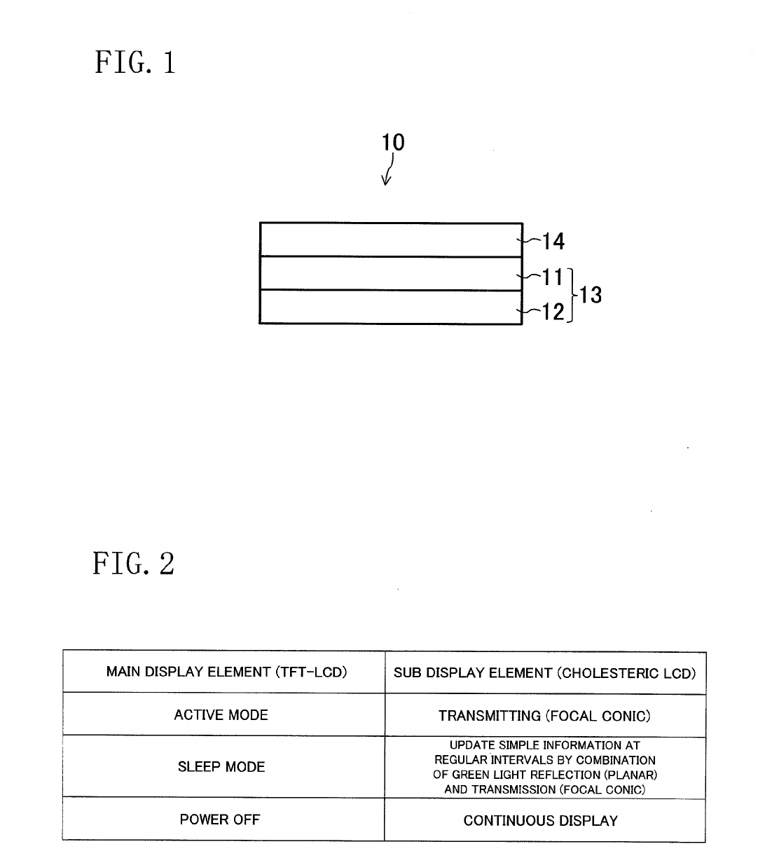

FIG. 1 is a cross-sectional view of a display device 10 according to a first embodiment of the present invention. The display device 10 includes a main display element 13 and a sub display element 14. The main display element 13 is formed by a liquid crystal display (LCD) element 11 having a thin film transistor (TFT) substrate, and a backlight 12. The sub display element 14 is a cholesteric liquid crystal display element, and is provided on the viewer side of the main display element 13.

The LCD element 11 of the main display element 13 includes the TFT substrate, a color filter substrate (a CF substrate) provided so as to face the TFT substrate, and a liquid crystal material and spacers (both not shown) which are interposed between the TFT substrate and the CF substrate.

The TFT substrate has a plurality of unit display regions (pixels) arranged in a matrix pattern. The CR substrate includes red (R), green (G), and blue (B) color filters, and a red, green, or blue color filter is positioned in each of the regions corresponding to pixels of the TFT substrate.

The sub display element 14 includes: upper and lower transparent substrates facing each other with spacers therebetween; upper electrodes arranged in a stripe pattern on the upper transparent substrate; lower electrodes arranged in a stripe pattern on the lower transparent substrate; and a cholesteric liquid crystal material (not shown) interposed between the upper and lower transparent substrates. The sub display element 14 has a plurality of unit display regions. It is preferable that the sub display element 14 be provided in close contact with the main display element 13.

In the cholesteric liquid crystal, nematic liquid crystal spontaneously has a helical structure. The cholesteric liquid crystal is in a planar state when the helical axis of the helical structure extends in the same direction as that of a normal to a panel, and is in a focal conic state when the helical axis extends perpendicularly to the normal to the panel.

In the planar state, Bragg reflection (selective reflection) occurs between helical pitches of the liquid crystal. The wavelength of the selective reflection is determined by the helical pitches. If the wavelength of the selective reflection is within a visible light range, the cholesteric liquid crystal in the planar state provides a vivid color.

On the other hand, in the focal conic state, the helical axis is perpendicular to the normal to the panel, and small domains are randomly distributed in a plane. Incident light from the panel is weakly scattered at domain boundaries, but can be regarded as transparent.

Selective reflection in the planar state, and weak scattering in the focal conic state that can be regarded as transparent can be switched by changing the pulse level of an applied voltage. Since the cholesteric liquid crystal is stable in both the planar and focal conic states (bistable), the cholesteric liquid crystal has been practically used in memory display elements.

In the first embodiment, the selective reflection wavelength of the cholesteric liquid crystal is 550 nm (green light is reflected). Note that the selective reflection wavelength is not limited to 550 nm, and may be any wavelength in the visible light range (that is, the selective reflection wavelength is not limited as long as the cholesteric liquid crystal reflects visible light).

(Display Method of Display Device 10)

A display method of the display device 10 according to the first embodiment of the present invention will be described below. FIG. 2 shows the relation between each mode of the main display element 13 and the display state of the sub display element 14. As shown in FIG. 2, when the main display element 13 is in an active mode, the sub display element 14 is in a transmitting (focal conic) state. When the main display element 13 is in a sleep mode, the sub display element 14 is in a combined state of a green light reflecting state (planar) and the transmitting state (focal conic). When the main display element 13 is off, the sub display element 14 continuously displays predetermined display information.

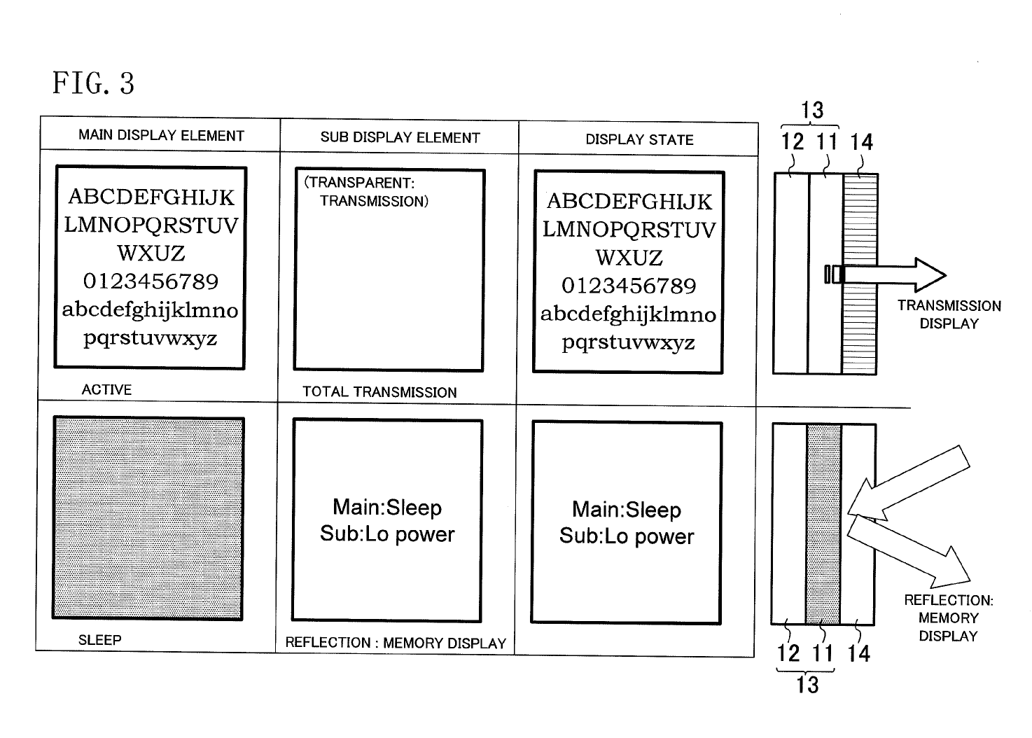

FIG. 3 shows plan views of the main display element 13 in each mode, and plan views of the sub display element 14 and cross-sectional views of the display device 10, which correspond to each mode of the main display element 13.

First, when the main display element 13 is in the active mode, all of the plurality of unit display regions of the sub display element 14 are in the transmitting state. Thus, display information displayed on a main screen of the main display element 13 is displayed on a screen of the display device 10.

Then, if the main display element 13 is turned off into the sleep mode, the main screen provides black (or dark) display. At this time, the sub display element 14 is simultaneously switched to a transmitting portion in the transmitting state, and a reflecting portion in the reflecting state. In the transmitting portion of the sub display element 14, the black (or dark) display information displayed on the main screen of the main display element 13 is displayed through a sub screen. The reflecting portion of the sub display element 14 blocks light from the main display element 13 side, while reflecting light from the viewer side. Thus, white (or bright) display information displayed on the sub screen is displayed in the reflecting portion of the sub display element 14.

At this time, desired simple display can be provided with low power consumption on the sub screen by controlling alignment of the cholesteric liquid crystal corresponding to each pixel of the sub display element 14. When the main display element 13 is in the sleep mode, the display on the sub display element 14 may be updated at regular intervals. For example, a date and time may be displayed on the sub screen of the sub display element 14, and may be updated every 60 seconds. A function to receive teletext broadcasting may be provided, and information may be updated every 5 minutes.

When returning the main display element 13 to the active mode, the main display element 13 is turned on, and at the same time, all of the plurality of unit display regions of the sub display element 14 are switched to the transmitting state. Thus, the main screen of the main display element 13 is displayed on the display device 10.

### Second Embodiment

(Configuration of Display Device 20)

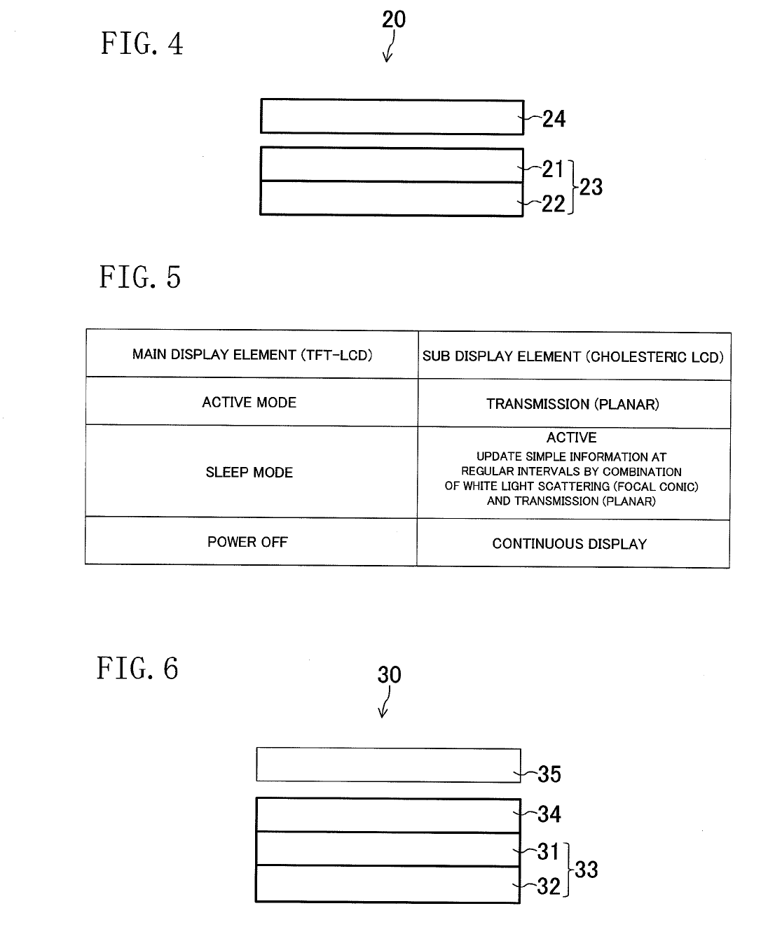

FIG. 4 is a cross-sectional view of a display device 20 according to a second embodiment of the present invention. The display device 20 includes a main display element 23 and a sub display element 24. The main display element 23 is formed by an LCD element 21 having a TFT substrate, and a backlight 22. The sub display element 24 is a cholesteric liquid crystal display element, and is provided on the viewer side of the main display element 23 with a predetermined gap therebetween.

Unlike the display device 10 of the first embodiment, the display device 20 uses cholesteric liquid crystal having a selective reflection wavelength of 800 to 1,000 nm (near infrared light). The selective reflection wavelength is 1,000 nm in the present embodiment. The display device 20 is different from the display device 10 only in that the main display element 23 and the sub display element 24 are provided with a predetermined gap therebetween.

The display device 20 of the second embodiment uses cholesteric liquid crystal having a selective reflection wavelength of 1,000 nm in the planar state. The planar portion is transparent since the selective reflection wavelength is a wavelength of near infrared light rather than visible light. On the other hand, in the focal conic portion, slight scattering is enhanced, resulting in scattering of white light. Since the predetermined gap is provided between the main display element 23 and the sub display element 24, light is reflected a plurality of times in an air layer between the sub display element 24 and the main display element 23. This increases the scattering intensity of white light.

(Display Method of Display Device 20)

A display method of the display device 20 according to the second embodiment of the present invention will be described below. FIG. 5 shows the relation between each mode of the main display element 23 and the display state of the sub display element 24. As shown in FIG. 5, when the main display element 23 is in an active mode, the sub display element 24 is in a transmitting (planar) state. When the main display element 23 is in a sleep mode, the sub display element 24 is in a combined state of a white light reflecting (focal conic) state and the transmitting (planar) state. When the main display element 23 is off, the sub display element 24 continuously displays predetermined display information.

The display method of the display device 20 of the second embodiment is carried out by steps similar to those of the first embodiment.

### Third Embodiment

(Configuration of Display Device 30)

FIG. 6 is a cross-sectional view of a display device 30 according to a third embodiment of the present invention. The display device 30 includes a main display element 33, a sub display element 34, and a front light 35. The main display element 33 is formed by an LCD element 31 having a TFT substrate, and a backlight 32. The sub display element 34 is a cholesteric liquid crystal display element, and is provided on the viewer side of the main display element 33. The front light 35 is provided on the viewer side of the sub display element 34.

The display device 30 corresponds to the display device 10 of the first embodiment further including the front light 35 over the sub display element 14. The front light 35 is turned on/off by a front light switch (not shown) electrically connected to a power source or the like.

(Display Method of Display Device 30)

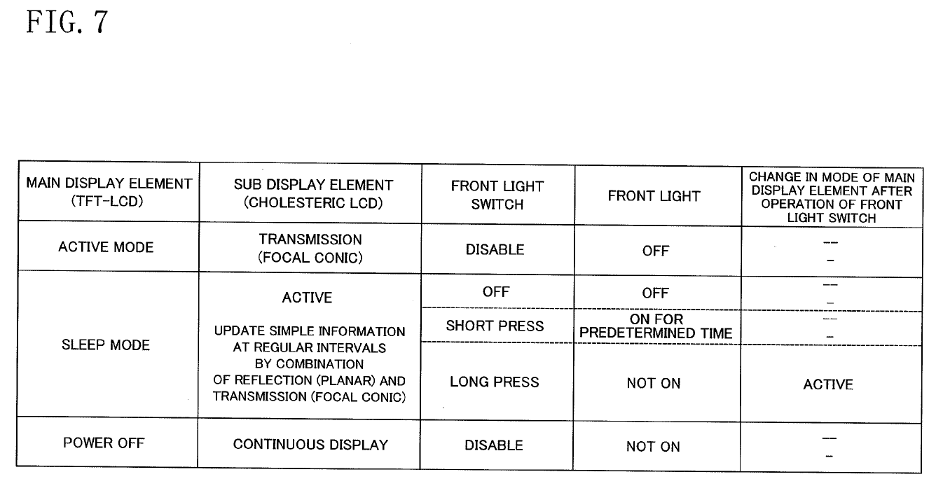

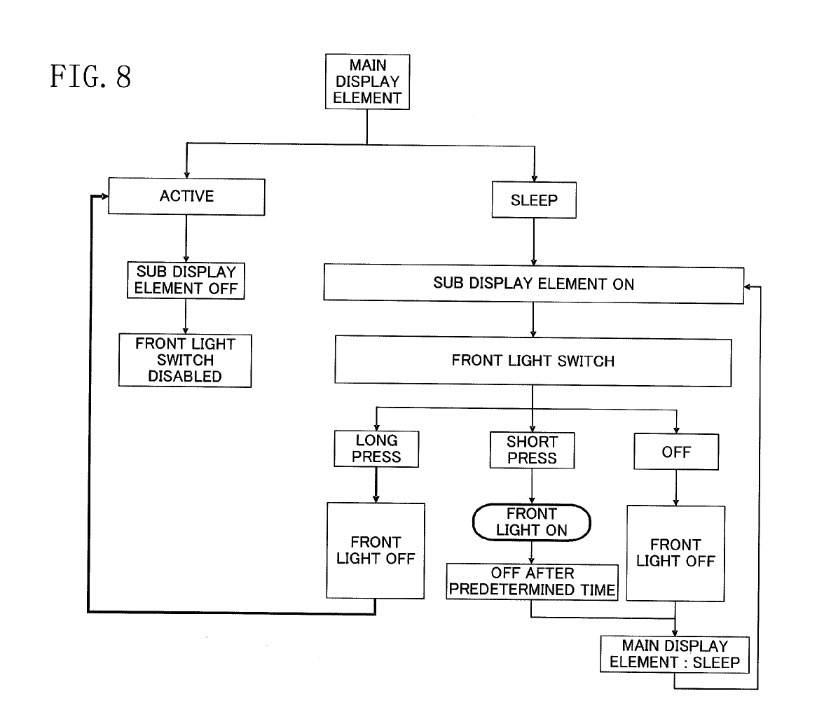

A display method of the display device 30 according to the third embodiment of the present invention will be described below. FIG. 7 shows the relation between each mode of the main display element 33 and the display state of the sub display element 34. FIG. 8 is a flowchart of a display system of the display device 30.

As shown in FIGS. 7-8, when the main display element 33 is in an active mode, all of a plurality of unit display regions of the sub display element 34 are in a transmitting state, and display information displayed on a main screen of the main display element 33 is displayed on a screen of the display device 30. At this time, the front light switch for controlling the front light 35 is disabled, and the front light 35 is off.

Then, if the main display element 33 is turned off into a sleep mode, the main screen provides black (or dark) display. At this time, the sub display element 34 is simultaneously switched to a transmitting portion and a reflecting portion. In the transmitting portion of the sub display element 34, the black (or dark) display information displayed on the main screen of the main display element 33 is displayed through a sub screen. The reflecting portion of the sub display element 34 blocks light from the main display element 33 side, and reflects light from the viewer side. Thus, white (or bright) display information displayed on the sub screen is displayed.

Then, the display device 30 can be switched to a desired display state by operating the front light switch in the following manner.

The front light 35 is turned off by a long press of the front light switch. The main display element 33 is switched to the active mode when the front light 35 is turned off.

The front light 35 is turned on by a short press of the front light switch. In this case, the front light 35 is automatically turned off after a predetermined time.

The front light 35 is turned off by turning off the front light switch.

The sub display element 34 continuously displays display information when the main display element 33 is turned off. At this time, the front light switch is disabled, and the front light 35 is off.

### Fourth Embodiment

(Configuration of Display Device 40)

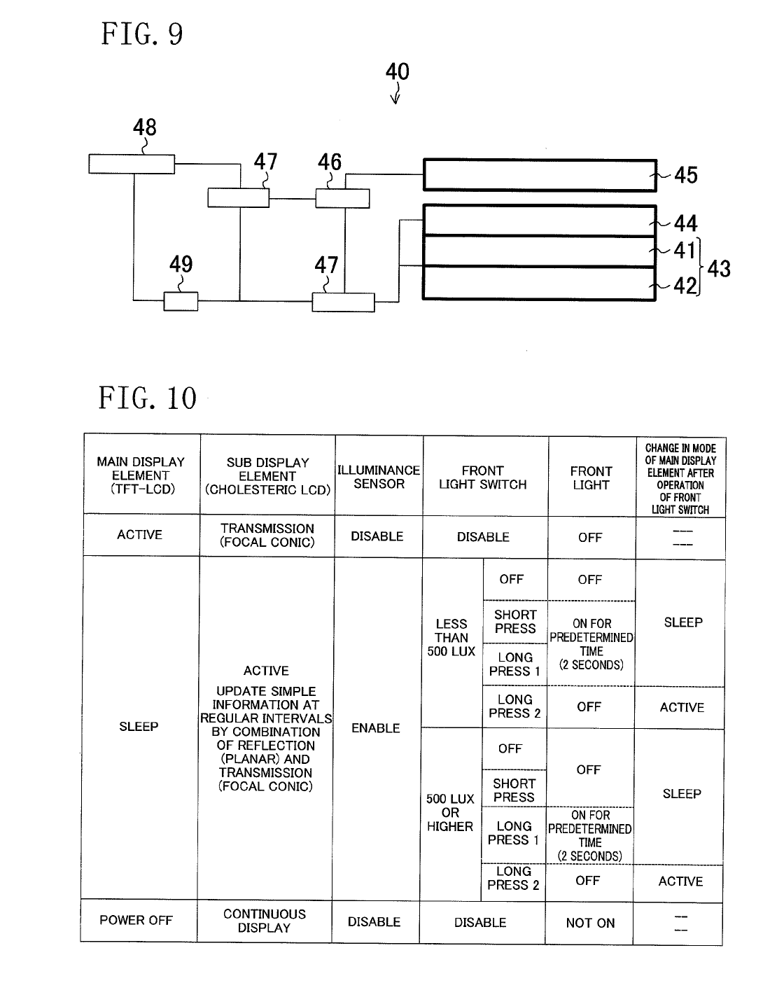

FIG. 9 is a schematic diagram of a display device 40 according to a fourth embodiment of the present invention. The display device 40 includes a main display element 43, a sub display element 44, a front light 35, an illuminance sensor 48, and a power source 49. The main display element 43 is formed by an LCD element 41 having a TFT substrate, and a backlight 42. The sub display element 44 is a cholesteric liquid crystal display element, and is provided on the viewer side of the main display element 43. The front light 45 is provided on the viewer side of the sub display element 44, and is controlled by a front light switch 46. The illuminance sensor 48 and the power source 49 are electrically connected to the front light switch 46 via an arithmetic circuit 47. That is, the display device 40 corresponds to the display device 30 of the third embodiment further including the illuminance sensor 48.

(Display Method of Display Device 40)

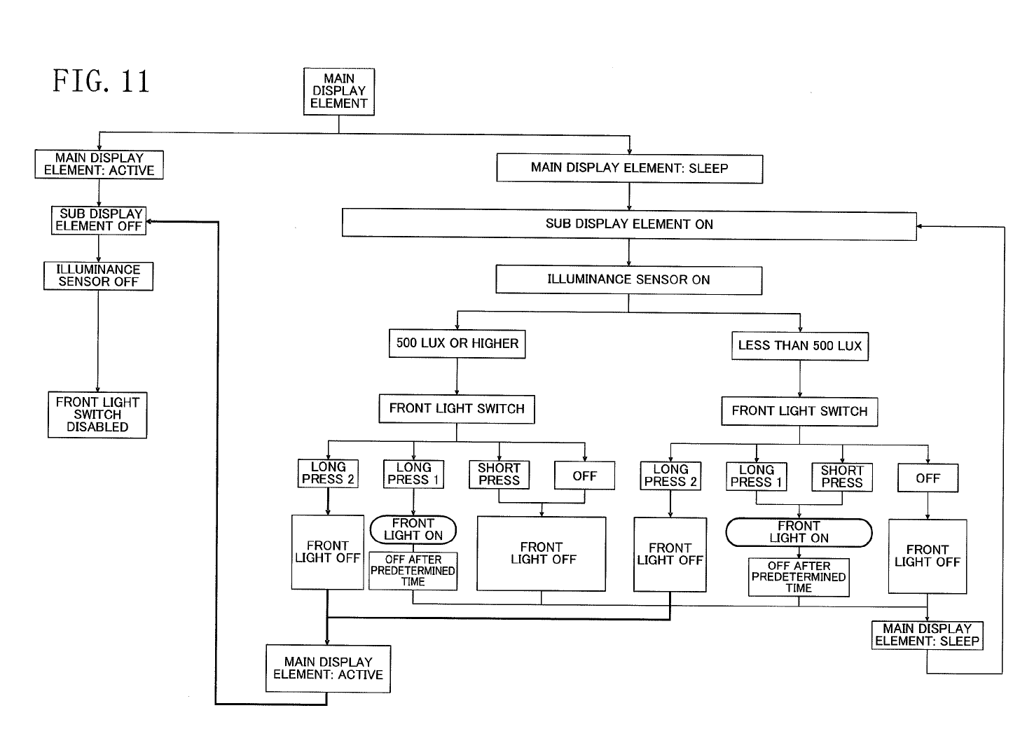

A display method of the display device 40 according to the fourth embodiment of the present invention will be described below. FIG. 10 shows the relation between each mode of the main display element 43 and the display state of the sub display element 44. FIG. 11 is a flowchart of a display system of the display device 40.

As shown in FIGS. 10-11, when the main display element 43 is in an active mode, all of a plurality of unit display regions of the sub display element 44 are in a transmitting state, and display information displayed on a main screen of the main display element 43 is displayed on a screen of the display device 40. At this time, the illuminance sensor 48 is off. The front light switch 46 for controlling the front light 45 is disabled, and the front light 45 is off.

Then, if the power source 49 of the main display element 43 is turned off to switch the main display element 43 into a sleep mode, the main screen provides black (or dark) display. At this time, the sub display element 44 is simultaneously switched to a transmitting portion and a reflecting portion. In the transmitting portion of the sub display element 44, black (or dark) display information displayed on the main screen of the main display element 43 is displayed through a sub screen. The reflecting portion of the sub display element 44 blocks light from the main display element 43 side, and reflects light from the viewer side. Thus, white (or bright) display information displayed on the sub screen is displayed.

Then, the illuminance sensor 48 is turned on to detect the illuminance around the display device 40. The front light 45, which is controlled by operating the front light switch 46, operates in different manners between when the detected illuminance is less than 500 lux, and when the detected illuminance is 500 lux or higher.

More specifically, the front light 45 operates in the following manner when the luminance is less than 500 lux. By turning off the front light switch 46, the front light 45 is turned off, and the main display element 43 remains in the sleep mode. By a short press or a long press 1 of the front light switch 46, the front light 45 is turned on and remains in the on state only for a predetermined time (e.g., 2 seconds), and the main display element 43 remains in the sleep mode. By a long press 2 of the front light switch 46 (an operation of pressing the front light switch 46 for a period longer than that of the long press 1), the front light 45 is turned off, and the main display element 43 is switched to the active mode.

On the other hand, the front light 45 operates in the following manner when the luminance is 500 lux or higher. By turning off the front light switch 46 or by a short press thereof, the front light 45 is turned off, and the main display element 43 remains in the sleep mode. By a long press 1 of the front light switch 46, the front light 45 is turned on and remains in the on state only for a predetermined time (e.g., 2 seconds), and the main display element 43 remains in the sleep mode. By a long press 2 of the front light switch 46 (an operation of pressing the front light switch 46 for a period longer than that of the long press 1), the front light 45 is turned off, and the main display element 43 is switched to the active mode.

When the power source 49 of the main display element 43 is turned off, the sub display element 44 continuously displays display information. At this time, the illuminance sensor 48 and the front light switch 46 are disabled, and the front light 45 is off.

Note that although the display devices 10-40 of the first to fourth embodiments use a backlight TFT-LCD as a component of the main display element, an organic electroluminescence (EL) display, a cathode ray tube (CRT) display, an inorganic EL display, a plasma display, a surface-conduction electron-emitter display (SED), or the like may be used instead of the backlight TFT-LCD. It is desirable that the main display element provide black display in the sleep mode. Note that in the case where the main display element provides dark blue display in the sleep mode, white/blue display can be provided by using cholesteric liquid crystal that reflects yellow light.

The display methods of the first to fourth embodiments are capable of satisfactorily switching display between a main screen and a sub screen of various display devices at desired timings, and are capable of reducing power consumption.

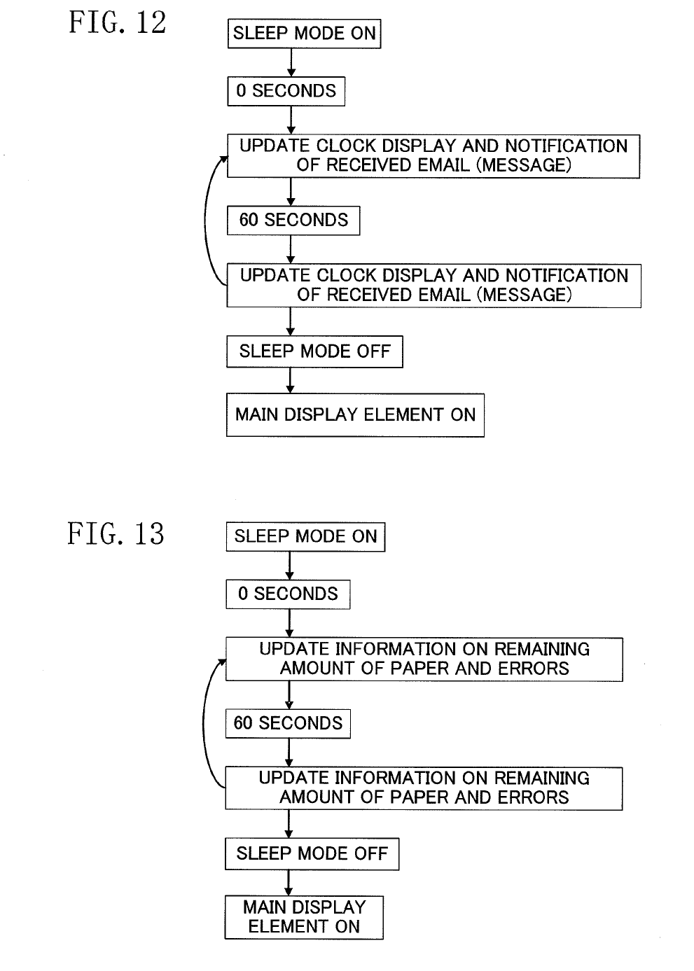

For example, in the case of a mobile phone, as shown in FIG. 12, clock display and notification of a received email (or message) on the sub screen are updated as soon as the main display element is switched to the sleep mode. This update is performed at regular intervals, e.g., every 60 seconds. By turning on the main display element from the sleep mode, the display of the sub display element is terminated, and a normal main screen of the mobile phone is displayed.

As described above, since the display device is provided with the illuminance sensor, the front light is not turned on even if the front light switch is accidentally pressed in a bright environment. This prevents or reduces excessive power consumption. Note that, in this case, a switch for terminating the sleep mode of the main display element may be separately provided.

FIG. 13 illustrates an example in which the display flow of the mobile phone shown in FIG. 12 is applied to a copier. When the main display element is in the sleep mode, information on the remaining amount of paper and errors are updated at regular intervals. Thus, simple display information can be displayed with reduced power consumption. By turning on the main display element from the sleep mode, the display of the sub display element is terminated, and a normal main screen of the copier is displayed.

Although not shown in the figure, in the case of televisions as well, a timer recording program list, time, date, or the like can be updated, e.g., every 60 seconds, or only a part of the information, such as time, can be updated. In the televisions, the most recently received channel can be displayed on the screen. Thus, if the screen is dark even after the television is turned on, the user will immediately know that it is because the power source of the television is off. Since the user can easily check the list of scheduled timer recordings, and the timer recording status, the user can manage timer recordings in a preferable manner. By updating the display information on the sub screen at regular intervals, emergency broadcasting information can be provided on the televisions and the like. Even if a power failure occurs, the most recent information before the power failure is still displayed on the screen. Since the most recent information before the power failure is available, each individual can take optimal action by determining the amount of time that has passed since the power failure.

### INDUSTRIAL APPLICABILITY

As described above, the present invention is useful for display devices and display methods thereof.

1. A display method of a display device having a main display element, and a sub display element provided on a viewer side of the main display element, the sub display element having a plurality of unit display regions that are switched to a reflecting portion and a transmitting portion by rewriting display information, the method comprising:
when the main display element is in an active mode, switching all of the plurality of unit display regions to the transmitting portion for displaying display information of the main display element; and
when the main display element is in a sleep mode in which the main display element provides black or dark display, switching the plurality of unit display regions to the transmitting portion for displaying the black or dark display information of the main display element, and a reflecting portion for displaying white or bright display information by blocking light from a main display element side and reflecting light from a viewer side.

2. The display method of claim 1, wherein
when the main display element is in the sleep mode, the display on the sub display element is updated at regular intervals.

3. The display method of claim 1, wherein
the sub display element is a memory display element.

4. The display method of claim 3, wherein
the memory display element is a cholesteric liquid crystal display element that reflects visible light.

5. The display method of claim 1, wherein
a front light is further provided on a viewer side of the sub display element to display information.

6. The display method of claim 5, wherein
the front light is controlled by an illuminance sensor.

7. A display device, comprising:
a main display element; and
a sub display element provided on a viewer side of the main display element, wherein
the sub display element has a plurality of unit display regions that are switched to a reflecting portion and a transmitting portion by rewriting display information, wherein
when the main display element is in an active mode, all of the plurality of unit display regions are switched to the transmitting portion for displaying display information of the main display element; and
when the main display element is in a sleep mode in which the main display element provides black or dark display, the plurality of unit display regions are switched to the transmitting portion for displaying the black or dark display information of the main display element, and a reflecting portion for displaying white or bright display information by blocking light from a main display element side and reflecting light from a viewer side.

8. The display device of claim 7, wherein
the sub display element is a memory display element.

9. The display device of claim 8, wherein
the memory display element is a cholesteric liquid crystal display element that reflects visible light.

10. The display device of claim 7, further comprising:
a front light provided on a viewer side of the sub display element.

11. The display device of claim 10, further comprising:
an illuminance sensor for controlling the front light.
